(19) United States
(12) Patent Application Publication
(10) Pub. No.: US 2011/0114121 A1
(43) Pub. Date: May 19, 2011

(54) LAMINAR FLOW TANK

(76) Inventor: Kenneth C. Miller, Fremont, CA (US)

(21) Appl. No.: 12/946,149

(22) Filed: Nov. 15, 2010

Related U.S. Application Data
(60) Provisional application No. 61/261,715, filed on Nov. 16, 2009.

(51) Int. Cl. B08B 3/12; B08B 3/00

(52) U.S. Cl. 134/10; 134/184; 134/1

(57) ABSTRACT

A cleaning apparatus is provided. The cleaning apparatus includes a tank defined by sidewalls extending from a base. A plurality of fluid outlets defined within an upper portion of opposing sidewalls are arranged as an array extending across a length and depth of the upper portion. The plurality of fluid outlets are configured to provide horizontally aligned fluid streams into an interior of the tank. The horizontally aligned fluid streams arranged such that an uppermost stream proceeds to an inner mid region of the tank and each successively lower stream proceeds closer to a sidewall from which the successively lower stream emanates, laminarly changing the direction of each of the horizontally aligned fluid streams to vertically aligned fluid streams toward a bottom of the tank. A support nest is disposed in a lower portion of the tank. A recirculation pump is disposed below the base of the tank. A method of cleaning a substrate is also provided.

### CLAIM OF PRIORITY

This application claims priority from U.S. provisional application No. 61/261,715, filed on Nov. 16, 2009, and entitled “LAMINAR FLOW TANK,” which is hereby incorporated by reference.

### BACKGROUND

Many processes for semiconductor and magnetic media manufacturing require extremely clean workpieces before the processes may start. Particulates or contaminants that attach to, or form on, the workpiece before processing may eventually cause defects in the workpiece. When the workpieces are disks to be processed, such particulates or contaminants may be materials adhered to the workpiece due to a processing operation. These particulates or contaminants may also be difficult to remove due to charge potentials of the contaminant and/or workpiece. Any of these defects not only lower the effectiveness of the magnetic layer to store the information but also can cause the crash of read-write heads that are flying over the platen at typically 1-2 nm fly height. Any nanoasperity is equivalent to an insurmountable mountain to avoid.

The cleaning process is intended to remove substantially all of the particulates or contaminants from workpieces before and after processing operations, such as processing of magnetic media or semiconductor workpieces. A clean workpiece is thus a workpiece from which substantially all of such particulates or contaminants have been removed before and after processing operations.

Therefore, there is a need for improving techniques for cleaning workpieces, such as those workpieces that present problems and require removal of substantially all of such particulates or contaminants from the workpieces before and after processing. Moreover, these improved techniques must allow cleaning of a workpiece to be done quickly so as to reduce the cost of capital equipment for the cleaning and to provide a clean substrate to alleviate additional process burdens during downstream processing operations.

It is within this context that embodiments of the invention arise.

### SUMMARY OF THE INVENTION

Broadly speaking, embodiments of the present invention fill these needs by providing methods of and apparatus configured to efficiently clean workpieces, especially substrates for the disk drive industry.

In one embodiment, a cleaning apparatus is provided. The cleaning apparatus includes a tank defined by sidewalls extending from a base. A plurality of fluid inlets defined within an upper portion of opposing sidewalls is provided. The plurality of fluid ports are arranged as an array extending across a length of the upper portion and a depth of the upper portion. The plurality of fluid ports are configured to provide horizontal fluid streams into an interior of the tank. The horizontal fluid streams are arranged such that an uppermost stream proceeds to an inner mid region of the tank and each successively lower stream proceeds closer to a sidewall from which the successively lower stream emanates. A support nest is disposed in a lower portion of the tank. The support nest is configured to support and rotate a plurality of substrates in a vertical orientation. A pump is disposed below the base of the tank. The pump is configured to recirculate fluid from a bottom of the tank through the sidewalls to the fluid ports.

In another embodiment, a method of cleaning a substrate is provided. The method initiates with disposing a plurality of vertically oriented substrates within a lower portion of a tank and flowing a fluid into the tank. The fluid is recirculated within the tank. The recirculating includes flowing the fluid into a top potion of the tank as a plurality of horizontally aligned fluid streams, wherein an uppermost fluid stream of the horizontally aligned fluid streams travels to a mid region of the tank and each successively lower fluid stream of the horizontally aligned fluid streams travels a successively reduced distance into the tank. A direction of each of the horizontally aligned fluid streams is laminarly changed to a vertically aligned fluid stream toward the bottom of the tank. The laminarity change occurs at different radial points across the tank above the vertically oriented substrates for each of the horizontally aligned fluid streams. The substrates are rotated while recirculating the fluid.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings.

FIG. 1 is a simplified schematic diagram illustrating an overview of a substrate cleaning system using a fluid distribution network in accordance with one embodiment of the invention.

FIG. 2 is a simplified schematic diagram illustrating a cross sectional view of the components of the laminar flow tank in accordance with one embodiment of the invention.

FIG. 3 is a simplified schematic diagram illustrating a front view of the nozzle's within the side wall of the laminar flow tank in accordance with one embodiment of the invention.

FIGS. 4A and 4B are exemplary views of the alignment of the vertical and horizontal channels of the vertical distribution plate and the horizontal distribution plate that may be incorporated into the sidewall of the tank for the eddy killer, lip exhaust, or over spray features in accordance with one embodiment of the present invention.

FIG. 5 is a simplified diagram illustrating the support structure for the substrates in the laminar flow tank in accordance with one embodiment of the invention.

FIG. 6 is a schematic diagram illustrating the roller assemblies of the support structure and the substrate in accordance with one embodiment of the present invention.

FIG. 7A is a simplified schematic diagram illustrating the cross-sectional view of the piston pumps providing recirculation for the laminar flow tank in accordance with one embodiment of the invention.

FIG. 7B is a simplified schematic diagram illustrating a bottom view of a quad piston pump configuration for the laminar flow tank in accordance with one embodiment of the invention.

### DETAILED DESCRIPTION

The embodiments described below relate to an apparatus for cleaning a workpiece. In one embodiment, the apparatus may be used to clean magnetic disk substrates. It should be appreciated that the embodiments are not limited to cleaning magnetic disk substrates, in that any semiconductor circuit device, flat panel display, or other substrate may be supported for cleaning by the embodiments described herein. The terms workpiece, wafer, and disks, as used herein may refer to any substrate being processed. In addition, the terms disk and disc are used interchangeably, and may also reference any such substrate or workpiece.

The embodiments can be used in the processing of substrates ranging from silicon wafers used in semiconductor manufacturing, to aluminum, ceramic, plastic, glass, composite, multi-component disks and the like used in the fabrication of data storage devices such as hard drive disks (HDDs), compact discs (CDs), digital versatile discs (DVDs) and the like used in the information, computer and entertainment industries. As used herein, the term “disk” is used as all-inclusive of any of the various substrates used in the media and data storage fields, and including HDDs, CDs, DVDs, mini-discs, and the like. Throughout this Detailed Description, “substrate” is used in a generic sense to include both wafers and disks (also referred to as discs). In the following description, numerous specific details are set forth in order to provide a thorough understanding of the present invention. It will be understood, however, to one skilled in the art, that the present invention may be practiced without some or all of these specific details. In other instances, well known process operations have not been described in detail in order not to unnecessarily obscure the present invention.

The laminar flow tank described herein includes an eddy killer that provides multiple different streams of fluid to be generated so that each successive stream results in uniform laminar flow across a diameter\width of the laminar flow tank. In one embodiment the eddy killer is a column of nozzles or ports where a topmost nozzle will generate a stream that proceeds across a radial distance of the laminar flow tank and each lower nozzle generates a stream of fluid that successively proceeds across a smaller distance of the tank. As illustrated below, each fluid stream prevents the next higher fluid stream from forming into an eddy current or turbulent flow. The fluid may be provided to the eddy killer through a suitable pump and the dimensions of each nozzle of the eddy killer may be configured so that a single pump providing fluid to the eddy killer will result in fluid streams having different velocity profiles across the tank. In one embodiment the nozzles are configured so that a smaller diameter nozzle is provided at a topmost position of the eddy killer and each successively lower nozzle has an increasing diameter. In another embodiment each of the nozzles of the eddy killer may be independently supplied with a fluid stream and the diameters or surface area of the openings are uniform. In alternative embodiments, the nozzles may be rectangles or a long slit with varying width. It should be appreciated that numerous shapes or configurations may be utilized with the embodiments described herein to maintain the laminar flow fluid streams. A pump provided at the bottom of the laminar flow tank generates the downward laminar flow that sweeps across a surface of the disk being cleaned. In one embodiment the eddy killer may utilize the laminated wall for uniform fluid flow to distribute the fluid to the nozzles of the eddy killer as described in U.S. application Ser. No. 12/122,571, which is incorporated by reference in its entirety for all purposes. In another embodiment the support structure for supporting a plurality of discs may utilize the support structure for multiple workpiece support rollers where the rollers are keyed so as not to independently move. For example, the impellers described herein can be used to drive the shaft, which in turn drives each roller to impart rotation to the discs. Further details of the support structure may be found in U.S. application Ser. No. 12/359,173, which is incorporated by reference in its entirety for all purposes.

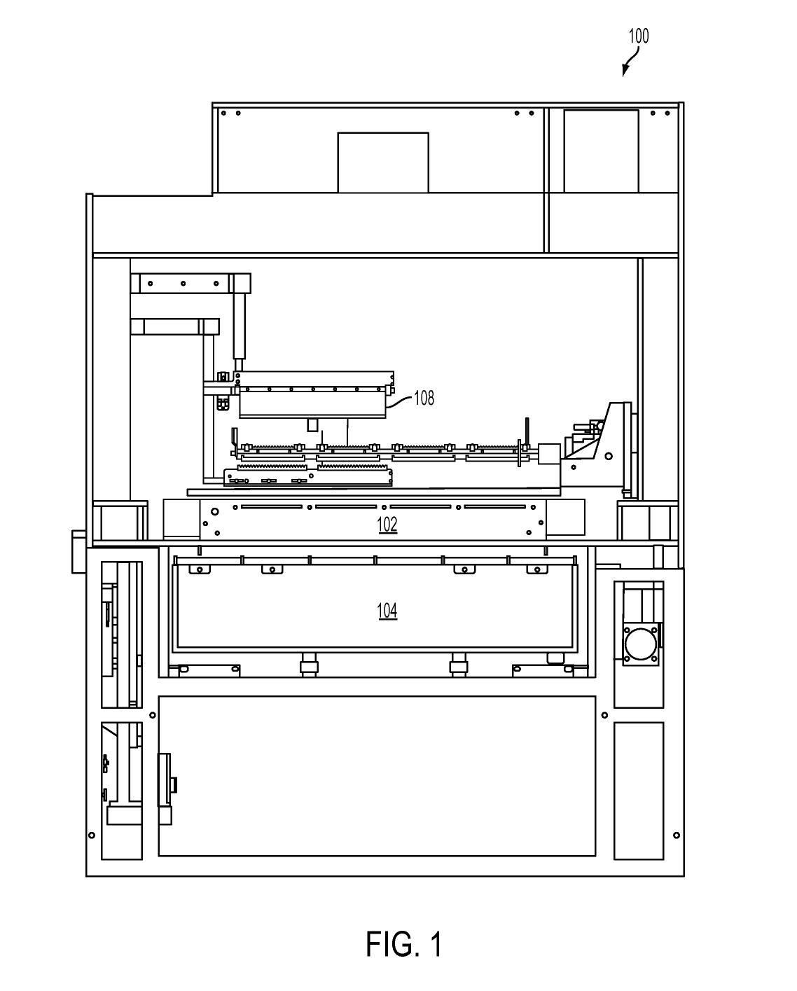

FIG. 1 is a simplified schematic diagram illustrating an overview of a substrate cleaning system 100 using a fluid distribution network in accordance with one embodiment of the invention. The substrate cleaning system 100 can include a drying chamber 102, a laminar flow tank 104, and a transport assembly 108. After controlled exposure within the laminar flow tank 104, substrate materials are moved via the transport assembly 108 to the drying chamber 102. For further information regarding the transport assembly 108, please see U.S. patent application Ser. No. 11/531,905, filed on Sep. 14, 2006 titled APPARATUS AND METHOD FOR DRYING A SUBSTRATE, which is herein incorporated by reference.

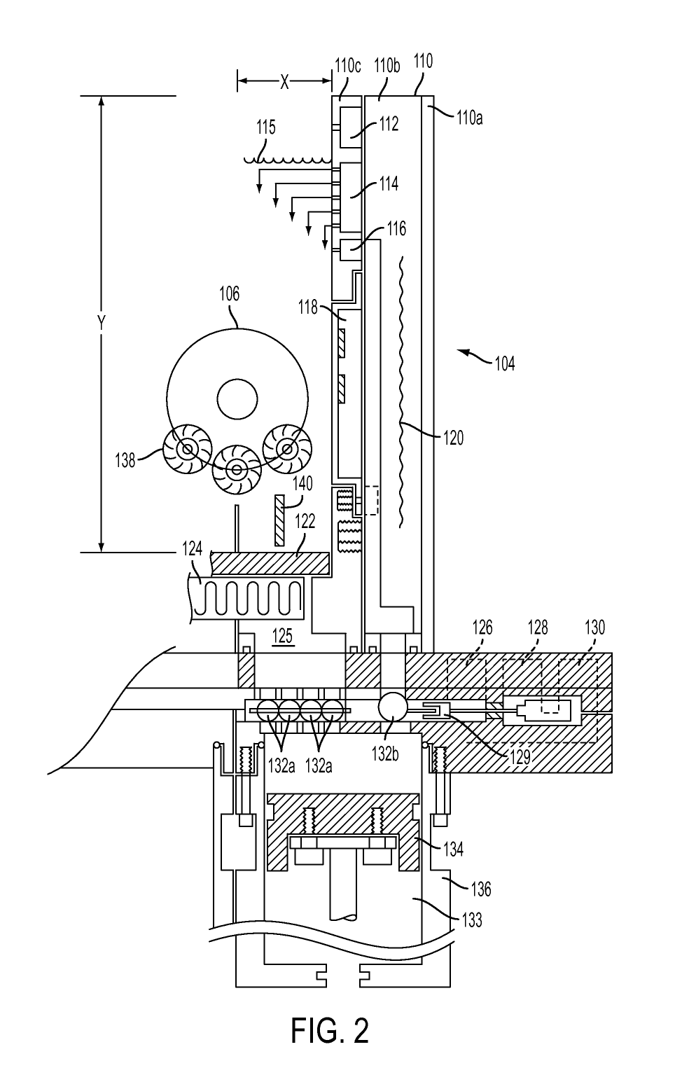

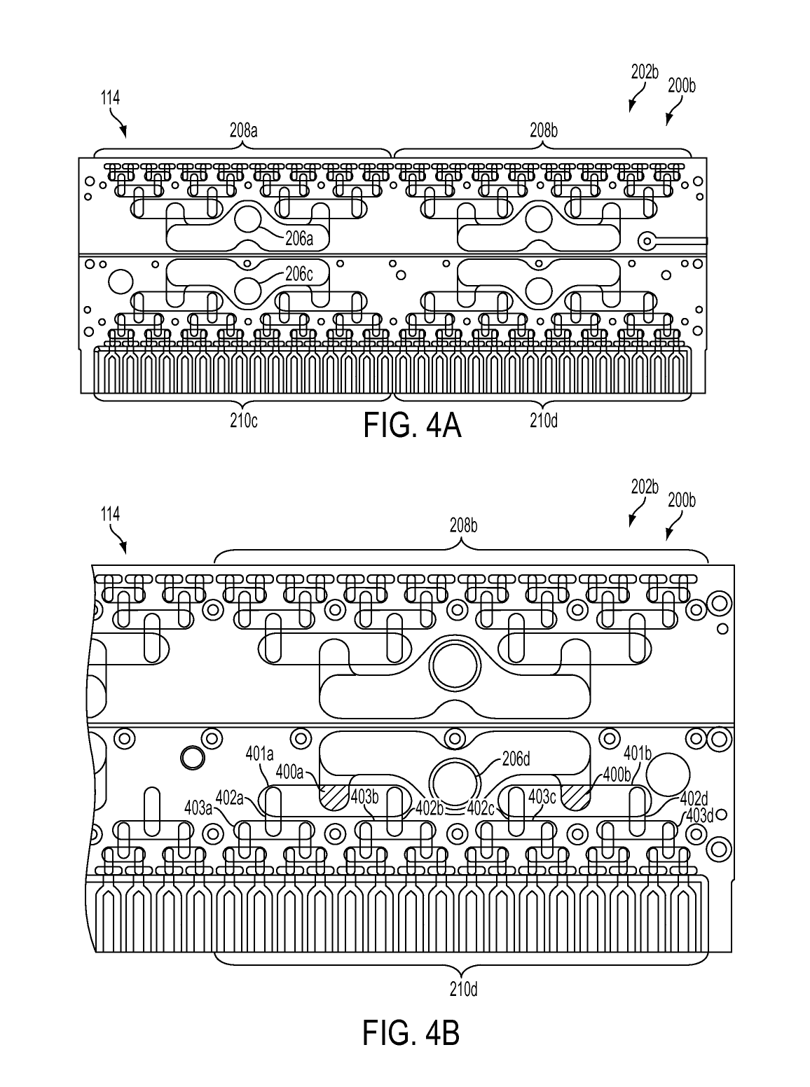

FIG. 2 is a simplified schematic diagram illustrating a cross sectional view of the components of the laminar flow tank in accordance with one embodiment of the invention. The laminar flow tank 104 includes sidewall 110 having a plurality of sections. It should be appreciated that another opposing sidewall to sidewall 110 is provided with laminar flow tank 104, however, for illustrative reasons a single right hand side is presented in FIG. 2. Thus, an opposing sidewall mirroring sidewall 110 is included with laminar flow tank 104. Sidewall 110 includes sections 110a, 110b, and 110c. It should be appreciated that any number of sections may be provided for sidewall 110. Beginning from an upper portion of sidewall 110, lip exhaust 112 is disposed within section 110c. Lip exhaust 110c captures any fumes or vapors emanating from a top of the water level 115 of tank 104. In one embodiment, lip exhaust 110c is in flow communication with a dedicated vacuum source in order to capture the fumes or vapors. Below the fluid level 115, once tank 104 is filled with a fluid, is eddy killer 114. Eddy killer 114 is configured to ultimately provide collimated vertical lines or currents of fluid streams under laminar flow in order to clean substrate 106. The fluid streams from eddy killer 114 originate in a horizontal direction and then proceed to a vertical direction toward the bottom of tank 104. As mentioned above, a corresponding eddy killer is disposed in an opposing sidewall to sidewall 110. Each eddy killer provides a first or uppermost fluid stream to a mid-region of tank 104 with successive streams being provided closer to a corresponding sidewall of the tank. In one embodiment, eddy killer 114 provides the fluid streams to tank 104 from a series of laminated walls that provide a uniform fluid flow to the nozzles disbursing the fluid streams from section 110c. Further details on the laminated walls are provided with reference to FIGS. 4A and 4B. In this embodiment, pump 133 recirculates fluid from tank 104 through diffuser plate 122, filter 124, past check valves 132a and 132b, heater 120, and through sidewall 110 to eddy killer 114 and back into the tank. The nozzles providing the fluid into tank 104 may be configured to provide a highest flow rate and pressure to an uppermost fluid stream and successively decrease the flow rate and pressure for successively lower nozzle of eddy killer 114. One skilled in the art will appreciate that this may be achieved by having a smaller size for the uppermost nozzle and successively increasing the size for each successively lower nozzle of eddy killer 114. In another embodiment the fluid stream supplied to each nozzle may be associated with a different flow rate and/or pressure where each nozzle has substantially the same size. Thus, a highest flow rate and pressure would be provided to an uppermost nozzle, while successively lower nozzles within eddy killer 114 are provided with successively lower flow rates and pressures of fluid. It should be noted that the size may increase for each successively lower nozzle in another embodiment. One skilled in the art will appreciate that the nozzles of eddy killer 114 are essentially an array of openings disposed within an upper portion of sidewall 110.

Disposed below eddy killer 114 is over spray 116, within section 110c of the sidewall. Over spray 116 is utilized to rinse substrate 106 prior to filling tank 104, assist in filling tank 104, or keeping substrate 106 wet during filling and draining operations. In another embodiment, over spray 116 may be utilized to neutralize a charge potential or provide a charge potential to the surface of substrate 106 to assist in a cleaning operation. For example, where a cleaning agent is impacted by a surface potential, over spray 116 may be utilized to provide the proper surface potential or wet the surface of substrate 106 in order to most efficiently clean substrate. In one embodiment, over spray 116 is provided with a different fluid source from eddy killer 114, as over spray 116 does not flow fluid while eddy killer 114 is flowing fluid. In another embodiment over spray 116 may be supplied from the same source as eddy killer 114, with valves utilized to control the fluid to eddy killer 114 and/or over spray 116.

Still referring to FIG. 2, module 118 includes a transducer is to provide sonic/acoustic energy to the fluid within tank 104 in order to aid in cleaning substrate 106. The relative location to the transducers within module 118 and substrate 106 is flexible. In one embodiment the transducers may be offset from or above a top surface of substrate 106 in order to have the acoustic energy attached to the fluid streams above a top edge of substrate 106. Alternatively, the transducers may supply acoustic energy from a location substantially in line with substrate 106. In yet another embodiment, the transducers of module 118 may be disposed within a bottom surface of tank 104. Heater 120 is embedded within wall 110 of tank 104. Heater 120 may be any suitable heater, such as a resistive heating element, capable of heating the fluid in the tank to about 80 degrees C. in one embodiment. In one embodiment, the fluid is deionized water, however, this is not limiting as any suitable cleaning fluid may be employed with the embodiments described herein. It should be appreciated that with the transducers located at the bottom of tank 104, the acoustic energy is provided in a direction parallel to the laminar flow fluid streams as opposed to the orthogonal orientation of the side wall embodiment. The bottom surface of tank 104 includes diffuser plate 122 and filter 124. Diffuser plate 124 assists in maintaining the laminar flow from the vertical fluid streams ultimately emanating from eddy killer 114. In one embodiment, diffuser plate 124 may be a plurality of screens layered over each other with a top layer having smaller area openings than a bottom layer. It should be appreciated that while FIG. 2 illustrates a single filter 124 alternative embodiments may include multiple filters. A plenum 125 is located below filter 124 and between a bottom surface of tank 104.

The bottom of tank 104 of FIG. 2 includes integrated check valves 132a, 132b and pump 133 disposed below the bottom of the tank. Check valves 132a and 132b enable the recirculation of fluid through pump 133. It should be appreciated that check valves 132a will lower during the downward stroke of pump piston 134, while check valve 132b rises during the upward stroke of piston 134 within pump tube 136. Optional valves 126, 128, and 130 are provided for a high rate of fill of tank 104, a low rate of fill of the tank, and a drain operation of the tank, respectively. In one embodiment, a single fill rate valve, rather than the high fill and the low fill rate vales, 126, and 128, respectively, is provided. Shifter plate 129 moves to provide the proper flow path depending on whether it is desired to fill or drain tank 104. It should be appreciated that an external pump, separate from pump 133 may be used for filling and draining purposes in one embodiment. In another embodiment, pump 133 may include two piston pumps so that an even flow is maintained to eddy killer(s) 114. Of course, other numbers of pumps, as well as alternative types of pumps may be utilized for pump 133 as long as the pump is capable of providing a recirculation flow to eddy killer 114. Further details of pump 133 are provided below. A substrate support 140 having impellers 138 is disposed in tank 104. In one embodiment, the substrate support is moveable in a vertical direction to transport substrates from an upper region of tank 104 to a lower region of the tank, e.g., such as a horizontal transport arm. Impellers 138 are driven by the laminar fluid flow streams proceeding to the bottom surface of tank 114 and are discussed in more detail below.

It should be appreciated that an alternative to the eddy killers disposed along a side wall of tank 104, is to provide a diffuser plate located at a top of the tank and flow the fluid through the diffuser plate to obtain the collimated laminar fluid streams. The diffuser plate is removeable or hinged to enable introduction of the substrates into the tank. The eddy killers disposed along the side wall of FIG. 2 enable an open top tank.

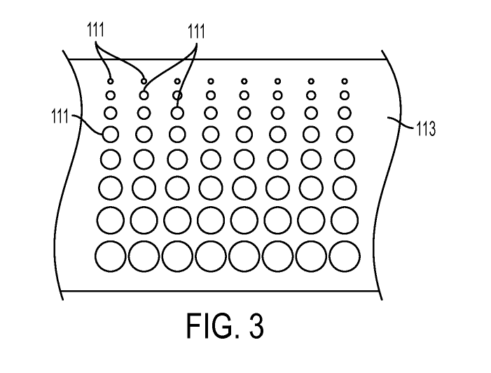

FIG. 3 is a simplified schematic diagram illustrating a front view of the nozzles within the side wall of the laminar flow tank in accordance with one embodiment of the invention. Surface 113 of the inner side wall of the laminar flow tank includes a plurality of nozzles 111. Nozzles 111 are disposed as an array across surface 113. In one embodiment nozzles 111 are openings within surface 113 so that surface 113 does not have any extensions into the tank to disrupt the laminar flow. As discussed above with reference to FIG. 2, nozzles 111 are located in an upper portion of the sidewall of the laminar flow tank.

Returning to FIG. 3, the array of openings across surface 113 are arranged such that the uppermost opening has a smaller diameter than each successively lower opening for each of the vertically aligned columns of the array. That is, the uppermost nozzles 111 having the smallest diameter provide a fluid stream that proceeds across a farthest radial distance of the tank prior to changing direction toward a bottom surface of the tank. Each successively lower nozzle 111 for each horizontally aligned fluid stream provides corresponding fluid streams that proceed less further into the tank prior to changing direction toward a bottom surface of the tank. One skilled in the art will appreciate that the different fluid streams emanating from nozzles 111 provide layered horizontal currents that essentially prevent eddy currents from developing as each lower fluid stream prevents the next higher fluid stream from forming into an eddy current as the fluid transitions to a vertical downward flow. In addition, through the suction provided from the pump at the bottom of the tank, the horizontal flow of each fluid stream changes to a vertical flow toward the bottom of the tank. The differing points of the change of direction across a radial distance of the tank for the fluid streams are dependent on a flow rate and pressure of the fluid stream at a nozzle of the eddy killer In addition, each row of the array of nozzles has a uniform diameter or size in one embodiment. It should be appreciated that alternates to the round shape of the nozzles include other geometric shapes, such as rectangles, squares, ovals, free-forms, etc.

FIGS. 4A and 4B are exemplary views of the alignment of the vertical and horizontal channels of the vertical distribution plate 110b and the horizontal distribution plate 110c that may be incorporated into the sidewall 104 of the tank for the eddy killer in accordance with one embodiment of the present invention. In this view, the horizontal distribution plate 200b has been made semi-translucent in order to see features of the vertical distribution plate 202b. In this embodiment, ports 206a-206d provide access to the distribution network formed by intersections between the horizontal distribution plate 200b and the vertical distribution plate 202b. As seen in FIG. 4A, port 206a provides fluid distribution and/or return to the plurality of ports 208a Likewise, ports 206b-206d can provide fluid distribution and/or exhaust to the respective ports 208b and ports 210c/d.

FIG. 4B illustrates additional details of the right side of the horizontal and vertical distribution plates shown in FIG. 4A. Fluid introduced through port 206d passes through a volumetric area created by the intersection between the channels of the horizontal distribution plate 200b and the vertical distribution plate 202b. Intersecting areas 400a/b allow the fluid to split into two separate horizontal channels in the horizontal distribution plate 200b.

In one embodiment, a summation of the cross-sectional area of a row of channels or ports will result in substantially equal numbers for every row within the horizontal distribution plate 200b. Similarly, the sum of the cross-sectional areas of the vertical channels remains substantially equal for vertical distribution plate 202b. Maintaining a same cross-sectional area between the rows of horizontal and vertical channels promotes uniform fluid flow to all of the ports 208 and 210.

Looking at the distribution network associated with port 206d, intersecting the two horizontal channels 401a/b are four vertical channels 402a-402d that transport the fluid to four horizontal channels 403a-403d. In some embodiments, horizontal channels 401a/b can be viewed as a row of horizontal channels while vertical channels 402a-402d can be viewed as a row of vertical channels. Similarly, horizontal channels 403a-403d can also be viewed as a row of horizontal channels. Thus, the distribution network can be viewed as a collection of intersecting vertical and horizontal rows. In the embodiment illustrated in FIG. 4B, the distribution network associated with port 206d can be viewed to have five rows of horizontal channels and five rows of vertical channels (including the ports 210d). This is slightly different than the distribution network associated with ports 208b that have five rows of horizontal channels and four rows of vertical channels.

In one embodiment, the sum of the cross-sectional areas for horizontal channels 401a/b is approximately equal to the sum of the cross-sectional area of horizontal channels 403a-403d. The fluid that passes through port 206d continues to be split vertically and horizontally until the fluid is evenly distributed across a specified length of the laminar flow tank. In this example, the fluid introduced through port 206d, eventually emerges from ports 210d and the sum of the cross-sectional area of ports 210 would be approximately equal to the sum of the cross-sectional area of horizontal channels 401a and 401b.

In some embodiments, summing the cross-sectional areas of each of the ports 210d could result in the cross-sectional area of the port 206d. It should be appreciated that the ports 210 of the laminated wall may be arranged such that one set of ports 210 is provided as the uppermost row for nozzles 111 in the array, with reference to FIG. 3, and another row of ports having a diameter different than the diameter of the nozzles in the uppermost row is arranged below the uppermost row and so on for each successive row. Thus, through the laminated wall, multiple rows of the openings having uniform flow rates and pressures within a row, and different flow rates/pressures between the rows, provide the array of openings/nozzles illustrated in FIG. 3. It should be appreciated that the laminated wall configuration may be incorporated into the lip exhaust and the overspray in a similar manner as described herein for the eddy killer of the laminar flow tank. Further details on the laminated flow walls may be found in application Ser. No. 12/122,571.

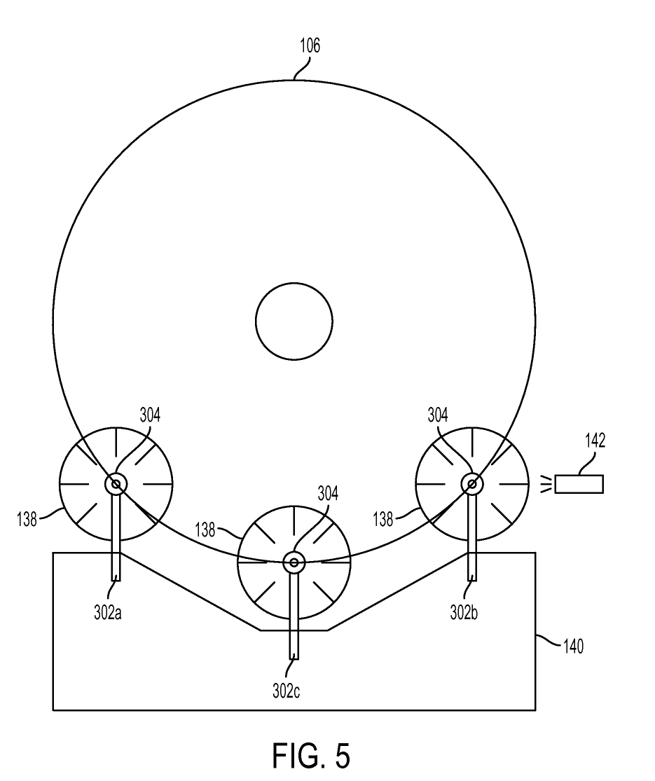

FIG. 5 is a simplified diagram illustrating the substrate support structure of the laminar flow tank in accordance with one embodiment of the invention. Support 140 is illustrating having three roller assemblies 302a through 302c extending therefrom. Roller assemblies 302a through 302c have impellers 138 extending from each end of the corresponding roller assemblies. Substrate 106 is supported by rollers 304. Impellers 138 are configured to rotate in a direction as driven by the laminar flow fluid streams provided through the nozzles of the eddy killer In one embodiment the blades extending outward of impellers 138 are in a paddlewheel configuration. In another embodiment, the blades extending outward are uniformly curved. As mentioned above, impellers 138 are rigidly attached to the shafts that extend along a length of support structure 140. It should be appreciated that substrate 106, in one embodiment, may rotate only one revolution while undergoing the cleaning process, accordingly a relatively slow rotation per minute (rpm) for impellers 138, e.g., 10 rpm, can provide the desired rotation rate for substrate 106. In one embodiment, jet 142 may be optionally utilized to drive impeller 138 by flowing a stream of fluid into the blades of the impeller. It should be noted that in this embodiment, each impeller has a dedicated jet. In another embodiment, gears or a mechanical link may be used to drive the shaft of the roller assemblies in lieu of the impellers.

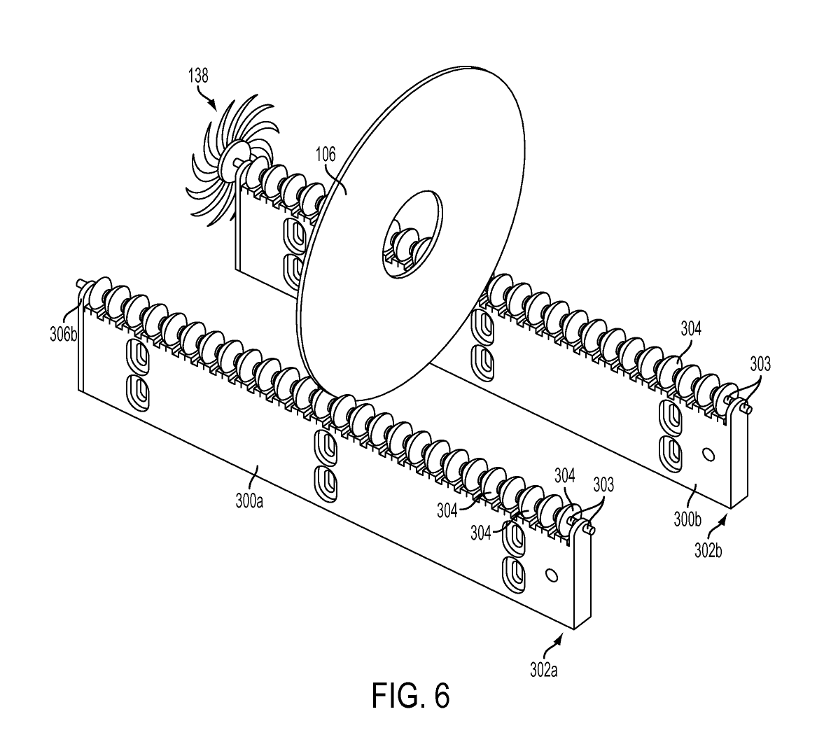

FIG. 6 is a schematic diagram illustrating roller assemblies 302a and 302b along with disc 106 in accordance with one embodiment of the present invention. The roller assembly 302a includes a carrier 300a, a shaft 303 and multiple rollers 304. The carriers 302a and 302b include impeller 138. A single impeller 138 is illustrated in FIG. 6 for exemplary purposes. One skilled in the art will appreciate that each end of roller assemblies 302a and 302b include an impeller 138 in one embodiment. In an alternative embodiment a single end of each roller assembly 302a and 302b may include impeller 138. In the embodiment of FIG. 6 the support includes two roller assemblies 302a and 302b, however, this is not meant to be limiting as more roller assemblies may be included, e.g., as illustrated with reference to FIG. 5 where three roller assemblies are provided.

In FIG. 6, rollers 304 are disposed along shaft 303. In one embodiment, each of rollers 304 is rigidly affixed to shaft 303 so that as shaft 303 rotates rollers 304 also rotate. In one embodiment the rigid attachment is achieved through a key disposed along shaft 303, although other known means of rigidly attaching rollers 304 to the shaft is within the scope of these embodiments. Shaft 303 extends through ends 306b of the roller assemblies so that impellers 138 may attach thereto. Impeller 138 is also rigidly affixed to shaft 303 in order to drive or rotate the shaft, which rotates rollers 304, which in turn rotates substrate 106. Impeller 138 is illustrated having curved blades, however this is not meant to be limiting as straight paddlewheel blades, or other impeller shapes may be integrated with the embodiments described herein. In one embodiment, impellers 138 may be oriented vertically with bevel gears driving shaft 303. It should be appreciated that alternative embodiments for driving shaft 303 are possible and the exemplary illustrations for driving the shaft through impeller 138, provided herein, are not meant to be limiting.

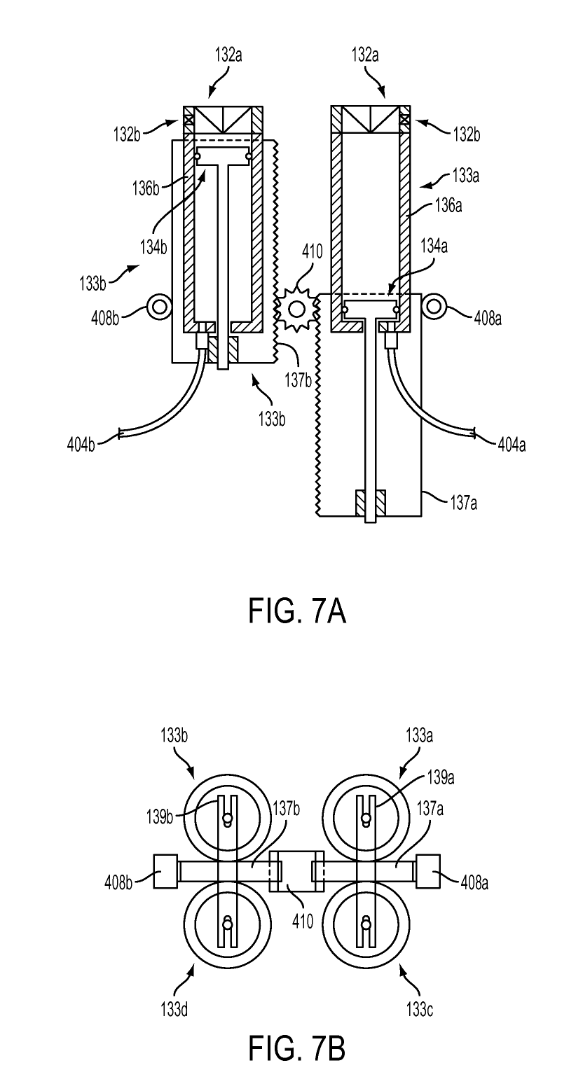

FIG. 7A is a simplified schematic diagram illustrating the cross-sectional view of the dual piston pumps providing recirculation for the laminar flow tank in accordance with one embodiment of the invention. Piston pumps 133a and 133b include pump tubes 136a and 136b, encompassing the respective piston, and pistons 134a and 134b which reciprocate inside the pump tubes. Gear 410 disposed between racks 137a and 137b and rollers 408a and 408b provide the reciprocating force for the piston pumps. Check valves 132a and 132b enable the piston pumps to function by alternately opening and closing in concert with the fluidic pressure provided by pistons 134a and 134b, therefore providing uniform recirculation of the fluid through the side walls of the laminar flow tank into the eddy killers and back through piston pumps 133a and 133b. In one embodiment, pistons 134a and 134b are alternately driven by air supplied through ports 404a and 404b, respectively, while the racks 137a and 137b and gear 410 reciprocally drive the pistons 134b and 134a, respectively.

FIG. 7B is a simplified schematic diagram illustrating a bottom view of a quad piston pump configuration for the laminar flow tank in accordance with one embodiment of the invention. Pumps 133a through 133d are disposed under the laminar flow tank. Gear 410 along with racks 137a and 137b, as well as rollers 408a and 408b, provide the means to reciprocally drive the pump pairs 133a and 133c in opposite directions to pump pairs 133b and 133d. The physical arrangement of gear 410 along with racks 137a and 137b, as well as rollers 408a and 408b provide balanced forces on the quad piston pump configuration. In one embodiment, racks 137a and 137b are disposed between the pistons and connected via tie bars 139a and 139b coupling the two adjacent pistons. One skilled in the art will appreciate that alternative pump configurations may be integrated with the embodiments described herein. In addition, alternative pump types may be substituted for the piston pumps illustrated with regard to FIGS. 7A and 7B.

The embodiments also provide a method for cleaning a substrate. The method includes disposing a plurality of vertically oriented substrates within a lower portion of a tank and flowing a fluid into the tank. The fluid is recirculated within the tank through a pump. The recirculating includes flowing the fluid into a top potion of the tank as a plurality of horizontally aligned fluid streams, wherein an uppermost fluid stream of the horizontally aligned fluid streams travels to a mid region of the tank and each successively lower fluid stream of the horizontally aligned fluid streams travels a successively reduced distance into the tank. A direction of each of the horizontally aligned fluid streams is laminarly changed toward the bottom of the tank. This laminarity direction change occurrs at different radial points across the tank which are above the vertically oriented substrates for each of the horizontally aligned fluid streams. The substrates are rotated while recirculating the fluid.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A cleaning apparatus, comprising;
a tank defined by sidewalls extending from a base;
a fluid outlet from the tank disposed proximate to the base;
a plurality of fluid inlet ports defined within an upper portion of opposing sidewalls, the plurality of fluid ports arranged as an array extending across a length of the upper portion and a depth of the upper portion, the plurality of fluid ports configured to provide horizontal fluid streams into an interior of the tank, the horizontal fluid streams arranged such that an uppermost stream proceeds to an inner mid region of the tank and each successively lower stream proceeds closer to a sidewall from which the successively lower stream emanates.

2. The cleaning apparatus of claim 1, further comprising:
a support nest disposed in a lower portion of the tank, the support nest configured to support and rotate a plurality of discs oriented in a vertical orientation.

3. The cleaning apparatus of claim 1, further comprising:
a pump disposed below the base of the tank, the pump configured to recirculate fluid from a bottom of the tank through the sidewalls to the fluid ports.

4. The apparatus of claim 2, wherein rotation of the plurality of discs is driven by the fluid streams.

5. The apparatus of claim 1, wherein the horizontal fluid streams flow in a first direction upon entering the tank and flow in a second direction when exiting the tank.

6. The apparatus of claim 5, wherein the first direction is about ninety degrees different than the second direction.

7. The apparatus of claim 2, wherein the support nest, comprises;
a shaft extending through a plurality of shaft supports;
a plurality of rollers disposed over the shaft supports, the plurality of rollers driven by rotation of the shaft.

8. The apparatus of claim 7, wherein the support nest further comprises:
an impeller rigidly affixed to each end of the shaft, the impeller having blades driven by the fluid streams.

9. The apparatus of claim 1, wherein the opposing sidewalls are comprised of a plurality wall sections affixed to each other.

10. The apparatus of claim 9, wherein one of the wall sections has a heater embedded therein and wherein another of the wall sections has a transducer configured to provide sonic energy into the fluid within the tank.

11. A cleaning chamber, comprising
a base with sidewalls extending from a surface of the base;
a fluid outlet from the tank; and
a plurality of columns of fluid ports defined along an upper portion of opposing sidewalls, wherein each of the columns of fluid outlets are configured to provide respective fluid streams arranged such that an uppermost fluid stream of the columns extends to a mid region of the chamber prior to changing direction toward the base of the chamber and each successively lower fluid stream of the columns extends less further into the chamber prior to changing direction toward the base of the chamber.

12. The cleaning chamber of claim 11, further comprising:
a support nest disposed within a lower portion of the chamber.

13. The cleaning chamber of claim 11, further comprising:
a pump disposed below the base, the pump configured to recirculate fluid from the lower portion of the chamber to an upper portion of the chamber through the sidewalls;

14. The chamber of claim 11, wherein the base includes a diffuser plate disposed over a filter.

15. The chamber of claim 13, wherein the pump is at least a pair of piston pumps, each piston pump of the pair of piston pumps having a cylinder housing with a rack coupled to each piston of the pair of piston pumps.

16. The chamber of claim 15, wherein each rack of the pair of piston pumps is coupled through a gear.

17. The chamber of claim 13, wherein the base includes a plurality of check valves enabling recirculation of the fluid through the pump and a plurality of valves enabling filling and draining of the tank through an external pump.

18. The chamber of claim 11, wherein one of the sidewalls has a heater embedded within a first section and a transducer configured to provide sonic energy into the fluid within the tank embedded within a second section.

19. A method of cleaning a substrate, comprising;
disposing a plurality of vertically oriented substrates within a lower portion of a tank;
recirculating a fluid through the tank, the recirculating comprising,
flowing the fluid into a top potion of the tank as a plurality of horizontally aligned fluid streams, wherein an uppermost fluid stream of the horizontally aligned fluid streams travels to a mid region of the tank and each successively lower fluid stream of the horizontally aligned fluid streams travels a successively reduced distance into the tank;
laminarly changing a direction of each of the horizontally aligned fluid streams to vertically aligned fluid streams toward a bottom of the tank, the laminarity change occurring at different radial points across the tank above the vertically oriented substrates for each of the vertically aligned fluid streams.

20. The method of claim 19, further comprising:
rotating the substrates while recirculating the fluid, wherein the rotating is accomplished by the fluid streams.

21. The method of claim 20, wherein the rotating includes,
rotating an impeller to drive a shaft coupled to rollers on which the vertically oriented substrates rest.

22. The method of claim 19, further comprising:
applying sonic energy to the fluid in the tank.

23. The method of claim 22, wherein the sonic energy is applied to the fluid streams above the vertically oriented substrates.

24. The method of claim 19, further comprising:
heating the fluid in the tank through a sidewall of the tank; and
filtering the fluid below the vertically oriented substrates.
